(19) United States
(12) Patent Application Publication
(10) Pub. No.: US 2023/0162962 A1
(43) Pub. Date: May 25, 2023

(54) DEFLECTORS FOR ION BEAMS AND MASS SPECTROMETRY SYSTEMS COMPRISING THE SAME

(71) Applicants: PerkinElmer Health Sciences, Inc., Waltham, MA (US); PerkinElmer Health Sciences Canada, Inc., Woodbridge (CA)

(72) Inventors: Tsung-Chi Chen, Shelton, CT (US); Hamid Badiei, Woodbidge (CA); Thomas White, Shelton, CT (US); Sergey Rakov, New Haven, CT (US); Adam J. Patkin, Hamden, CT (US)

(21) Appl. No.: 17/989,415

(22) Filed: Nov. 17, 2022

Related U.S. Application Data
(60) Provisional application No. 63/281,909, filed on Nov. 22, 2021.

(51) Int. Cl. H01J 49/06; H01J 49/10; H01J 49/34; G01N 30/72

(52) U.S. Cl. CPC H01J 49/061; H01J 49/10; H01J 49/067; H01J 49/34; G01N 30/7206

(57) ABSTRACT

Provided are ion detectors and systems that may employ such ion detectors such as mass spectrometers and other instruments. The ion detectors include a deflector that serves to generate an electric field with designed shape and strength that causes the ions passing into the detector to move along a deflection path. By selectively deflecting the charged ions from an initial propagation axis, the deflector effectively removes unwanted neutral particles from the ion path and reduces background in the resulting spectra.

### CROSS REFERENCE TO RELATED APPLICATIONS

This application depends from and claims priority to U.S. Provisional Application No. 63/281,909 filed Nov. 22, 2021, the entire contents of which are incorporated herein by reference.

### TECHNICAL FIELD

The present specification generally relates to deflectors for ion beams and mass spectrometry systems comprising the same.

### BACKGROUND

Among analytical methods for identifying, characterizing or detecting chemical or biological materials, mass spectrometry (MS) stands out for its high sensitivity, specificity, and wide dynamic range. In analytical chemistry, some applications, such as drug discovery, proteomics, and forensic science, use MS to, for example, identify elements and/or compounds, determine isotopic ratios, and explore chemical structures of unknown compounds. A mass spectrometer is an analytical instrument that measures the mass-to-charge ratio (m/z) of gas phase ions of compounds or fragments thereof. Most mass spectrometers include a source that ionizes target compounds and produces charged molecules or their fragments, a mass analyzer that separates charged particles based on their m/z, and a detector that creates a series of ion signals spread over time which forms mass spectra.

The power of MS may be enhanced by combining other analytical techniques that provide sample separation in orthogonal dimensions prior to the MS analysis. For example, in a gas chromatography (GC), compounds of a sample are dissolved in a solvent and vaporized to perform the separation by distributing between a stationary and mobile phase. The mobile phase is an inert gas that carries analytes though a heated column (the stationary phase).

Investigators using these analytical techniques are continually seeking improved resolution and/or signal to noise ratio to more effectively detect and characterize compounds. This disclosure provides devices and methods that address these needs.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided herein are detector assemblies that may be used in deflection of one or more ions such as in a mass spectrometry system. The provided assemblies improve detection and identification of ions within an ion beam.

As such, provided herein are ion detector assemblies that include a first particle shield comprising an ion entry opening for receiving an ion beam propagating along a first propagation axis; a deflector configured to generate an electric field in a deflection region that deflects the ion beam out of alignment with the first propagation axis along a deflection path; a second particle shield comprising an ion exit opening; and a detection element configured to convert and multiply the ion beam to electrons after deflection via the deflector, wherein: the first particle shield extends at an angle relative to the second particle shield, the first particle shield and the second particle shield define a corner region, and the deflector includes: a first rear surface extending proximate to the first particle shield; a second rear surface extending proximate to the second particle shield, a vertex where the first rear surface meets the second rear surface, the vertex being disposed proximate to the corner region; and a curved deflection surface opposite the vertex and extending between the first rear surface and the second rear surface.

In some aspects of the provided ion detector assemblies, the first rear surface extends about parallel to the first particle shield and the second rear surface extends about parallel to the second particle shield. Optionally, the angle at which the first particle shield extends relative to the second particle shield is optionally about 90°. According to any aspect, a portion of the deflection path optionally extends at a deflection angle of at least 90° relative to the first propagation axis. Optionally, the deflection path deviates from the first propagation axis in a deflection plane, and the deflection plane extends through both the ion entry opening and the ion exit opening. Optionally, in a cross section of the deflector taken through the deflection plane, the curved deflection surface follows a curved, optionally substantially circular, arc extending between a first outer edge of the first rear surface and a second outer edge of the second rear surface. Optionally, within the deflection region the electric field is configured to cause the deflection path to include a deflection radius with an end disposed at a vertex. As such, in some aspects, at least a portion of the curved deflection surface comprises a deflector radius of curvature, as measured from the vertex; and the deflector radius of curvature is less than the minimal deflection radius of curvature r_{dmin}, optionally wherein the deflector radius of curvature is greater than or equal to half of the minimal deflection radius of curvature r_{dmin}, In some aspects of any of the foregoing, the vertex extends substantially perpendicular to the first propagation axis. In some aspects of any of the foregoing, the deflector is substantially a quarter of a sphere centered on the vertex. In some aspects of any of the foregoing, the deflector is substantially a quarter of an ellipsoid centered on the vertex. In some aspects of any of the foregoing, the deflector comprises substantially a quarter of a cylinder centered on the vertex. In some aspects of any of the foregoing, wherein the deflector comprises a cross-sectional area that varies as a function of position along the vertex. In some aspects of any of the foregoing, a center of the ion entry opening and a center of the ion exit opening are disposed in a deflection plane containing the cross-sectional area, optionally wherein a minimum cross-sectional area of the deflector is contained in the deflection plane, or wherein a maximum cross-sectional area of the deflector is contained in the deflection plane. According to any of the foregoing, an ion detector assembly optionally further includes one or more ion focusing lenses disposed proximate to the ion entry opening and the ion exit opening, a conversion dynode disposed at an end of the deflection path, the conversion dynode configured to convert the ion beam into an electron beam, a conversion dynode disposed at an end of the deflection path, the conversion dynode configured to convert the ion beam into an electron beam, or any combination thereof.

Also provided are mass spectrometry systems that include: an ion source generating an ion beam; a mass analyzer configured to guide the ion beam along a first propagation axis; and a ion detector assembly comprising: a pair of particle shields extending at an angle to one another and forming a corner region, the pair of particle shields comprising an ion entry opening for receiving the ion beam and an ion exit opening; a deflector configured to generate an electric field in a deflection region that deflects the ion beam out of alignment with the first propagation axis along a deflection path extending through the ion exit opening, the deflector comprising a pair of rear surfaces and a vertex where the pair of rear surfaces meet; and a detection element configured to generate electronic signals from the ion beam after deflection via the deflector, wherein the electric field generated by the deflector comprises iso-potential lines that extend within about 10° of perpendicular to the one of the particle shields of the pair of particle shields in an area proximate to the ion exit opening.

Optionally, in a mass spectrometry system as provided in the foregoing, the system may further include a grounded enclosure configured to shape the iso-potential lines within the deflection region, the grounded enclosure surrounding the deflection region and the detection element. In some aspects, one of the particle shields of the pair of particle shields is configured to block the detection element from neutral species propagating through the mass analyzer. In any of the foregoing, optionally successive portions of the iso-potential lines extending proximate to the ion entry opening encountered by the ion beam extend at decreasing angles relative to the first propagation axis such that, within the deflection region, the deflection path comprises a deflection radius with an end disposed at the vertex. Optionally, the deflector includes a curved deflection surface, wherein at least a portion of the curved deflection surface includes a deflector radius of curvature, as measured from the vertex, that is greater than or equal to half of the deflection radius. Optionally, the vertex is disposed proximate to the corner region; and the curved deflection surface is opposite the vertex and extends between the pair of rear surface. In some aspects of any of the foregoing, the iso-potential lines extend substantially parallel to the rear surfaces proximate to the pair of particle shields. In some aspects of any of the foregoing, the vertex extends substantially perpendicular to the first propagation axis. Optionally, the deflector comprises a quarter of a sphere centered on the vertex, a quarter of an ellipsoid centered on the vertex, or a quarter of a cylinder centered on the vertex. Optionally, the deflector comprises a cross-sectional area that varies as a function of position along the vertex. In some aspects of any of the foregoing, the ion detector assembly further comprises one or more ion focusing lenses disposed proximate to the ion entry opening and the ion exit opening. In some aspects of any of the foregoing, the ion detector assembly further comprises a conversion dynode disposed at an end of the deflection path, the conversion dynode configured to convert the ion beam into an electron beam. Optionally, the ion detector assembly further comprises an electron/photon multiplier disposed between the detection element and the conversion dynode.

Also provided herein are methods of detecting an ion. Optionally, the methods use an ion detector assembly as provided herein. Optionally, the methods us a mass spectrometry system as used herein. In some aspects, a method of detecting an ion includes generating an ion beam propagating along a first propagation axis; blocking neutral particles propagating with the ion beam by transmitting the ion beam through an ion entry opening of a first particle shield; deflecting the ion beam off of the first propagation axis onto a deflection path by generating an electric field using a deflector disposed proximate a corner region disposed at an intersection between the first particle shield and a second particle shield, wherein the deflector comprises a pair of rear surfaces and a vertex where the pair of rear surfaces meet, the vertex being disposed proximate the corner region; blocking additional neutral particles by transmitting the ion beam through an ion exit opening in the second particle shield; and generating a detection signal from the ion beam using a detection element, wherein the electric field generated using the deflector comprises iso-potential lines that extend within 10° of perpendicular to the second particle shield in an area proximate to the ion exit opening.

In some aspects of any of the foregoing, a method further includes focusing the ion beam at one or more of the ion entry opening and the ion exit opening using one or more ion focusing lenses. Optionally, ions in the ion beam comprise a plurality of mass to charge ratios, and the method further includes applying a plurality of combinations of voltages to the deflector to direct the ions in the ion beam through the ion exit opening. In some aspects of any of the foregoing, the method further includes adjusting voltages applied to the deflector and to compensate for a kinetic energy distribution of the ions in the ion beam. Optionally, the kinetic energy distribution includes kinetic energies ranging from 0.1 eV to 75 eV. In some aspects of any of the foregoing, the method further includes generating an electron beam from the ion beam using a conversion dynode disposed at an end of the deflection path. Optionally the method further includes amplifying the electron beam using an electron/photon multiplier disposed between the conversion dynode and the detection element.

### BRIEF DESCRIPTION OF THE DRAWINGS

The embodiments set forth in the drawings are illustrative in nature, only examples, and not intended to limit the subject matter defined by the claims. The following detailed description of the illustrative embodiments can be understood when read in conjunction with the following drawings, where like structure is indicated with like reference numerals and in which:

FIG. 1 schematically depicts a mass spectrometry system, according to one or more embodiments described herein;

FIG. 2A schematically depicts a perspective view of an ion detector assembly of the mass spectrometry system of FIG. 1, according to one or more embodiments described herein;

FIG. 2B schematically depicts a perspective view of the ion detector assembly of FIG. 2A with a grounded enclosure removed, according to one or more embodiments described herein;

FIG. 2C schematically depicts a charge particle simulation of a cross-sectional view of the ion detector assembly through the line 2-2 of FIG. 2B, according to one or more embodiments described herein;

FIG. 3 schematically depicts a cross-sectional view of an ion detector assembly that may be used in a mass spectrometry system, according to one or more embodiments described herein;

FIG. 4 schematically depicts a perspective view of an ion detector assembly including a quarter sphere-shaped deflector, according to one or more embodiments described herein;

FIG. 5 schematically depicts a perspective view of an ion detector assembly including a quarter ellipsoid-shaped deflector, according to one or more embodiments described herein;

FIG. 6 schematically depicts a perspective view of an ion detector assembly including a deflector with a varying cross-sectional area, according to one or more embodiments described herein; and

FIG. 7 schematically depicts a perspective view of an ion detector assembly including a deflector with a quarter cylindrical sheet metal deflector, according to one or more embodiments described herein.

### DETAILED DESCRIPTION

While GC allows the analysis of a complex mixture (as discussed in the Background), the this disclosure recognizes and appreciates that introducing inert gas also raises background noise in a MS system that uses an electron impact (EI) or plasma source. These sources produce not only ions but also neutral species and photons that travel through the line-of-slight path to the ion detector resulting in noise in the ion signals. The existence of this undesirable noise limits the dynamic range of the detectors and shortens the lifetime of the ion detectors.

This disclosure further recognizes and appreciates that, in some applications, inert gases may undergo slow electron-atom collisions to form short-lived negative ions and decay into ground or metastable states. For example, helium metastable noise is commonly observed from a GC-MS system equipped with an EI source with helium as the carrier gas. These helium metastable atoms are initially uncharged and therefore are not affected by the potentials produced by any ion optics present in the system. Under the molecular flow environment, the kinetic energy theory of gases is the governing principle that affects the properties of uncharged particles. Specifically, under the kinetic energy theory of gasses, the metastable atoms and other gas molecules spread out and intermolecular collisions no longer dominate. In such situations, collisions with instrument components and the inner walls of the system's chambers become the primary factor affecting the properties of metastable atoms.

This disclosure recognizes and appreciates that significant reduction of metastable noise may be obtained by blocking a line-of-slight path to the detector. Such a technique for reducing noise is not self-evident because metastable species do not follow the ion path created by the device's ion optics. This disclosure, however, recognized and appreciated that these metastable species provide an energy source that can generate secondary ions that do move along the ion path provided by the ion optics. In some examples, ionization can occur via energy transfer to other atoms whose ionization energy is less than the excitation energy of the metastable atoms. For example, copper atoms with ionization energy of 7.86 eV mixed with an argon plasma, e.g., created by an inductively coupled plasma (ICP) source, can be ionized by colliding with metastable argon with respective energies of 11.55 and 11.75 eV. In a GC-MS system, possible contaminate residues, such as plasticizer, pump fluid vapor and calibrant residues, can be ionized by the metastable helium and contribute to the noise background. This ionization process can happen anywhere in the vacuum chamber of the MS system. Secondary ions generated before the mass analyzer section of the MS system may be distinguishable from the ion signal due to the difference in the mass spectrum. However, this disclosure recognizes and appreciates that secondary ions generated after the mass analyzer section of the MS system cannot be mass-resolved and will raise the baseline signal at all masses. Such an increase in the baseline signal will result in a reduction of the dynamic range of a GC-MS system. Accordingly, this disclosure recognizes and appreciates that the operation of some MS systems may be improved by reducing the quantity of such neutral particles proximate to the detector.

The present disclosure generally relates to deflectors for ion detector assemblies and mass spectrometry systems including the same that are capable of reducing neutral particles in proximity to the detector thereby reducing noise in the baseline signal. Some embodiments of the ion detector assemblies of the present disclosure may include a first particle shield including an ion entry opening for receiving an ion beam propagating along a first propagation axis, a deflector, a second particle shield including an ion exit opening, an optional detection element configured to convert and multiply the ion beam to electrons after deflection via the deflector, and optionally an enclosure to shield the entire deflection region and ion detection element. The deflector may be configured to generate an electric field that deflects the ion beam out of alignment with the first propagation axis along a deflection path that extends through the ion exit opening. The shape of the deflector may be designed to provide a potential distribution that allows better tolerance for wide kinetic energy distribution of ions being analyzed as compared with certain existing ion deflectors. Illustratively, according to some aspects, the deflector provides substantially lossless transmission on a spectra with m/z of 69-1022 with a kinetic energy range from 0.1 to 75 eV.

The deflector may include a first rear surface disposed proximate to the first particle shield and a second rear surface disposed proximate to the second particle shield. The first and second rear surfaces may meet at a vertex that is disposed proximate to a corner region where the first and second particle shield intersect (or are most proximate to one another). A deflection surface opposite the vertex may face the deflection path and define the potential distribution and create the electric field inward or outward to the vertex. By incorporating the rear surfaces and vertex, the curved deflection surface may include a deflector radius of curvature, referred to herein as r_{dc}, that may be greater than certain existing ion deflectors. In some aspects as provided herein, the deflector may include a surface defined by one or more piecewise polynomial functions that defines the curved surface. In either or both cases, the curved deflection surface may be extended proximate to the entrance and exit of the particle shields to minimize the field distortion between deflector and the shield electrodes. Such configurations may result in iso-potential lines associated with the electric field substantially corresponding in shape to the deflection path for a greater portion of the angular distance (e.g., as measured from the corner region) as compared to certain existing ion deflectors. Such correspondence between the iso-potential lines and the deflection path facilitates favorable ion trajectories. As a result, the ion beam may be deflected out of alignment with the first propagation axis with minimal ion loss to prevent the detection element from being exposed to neutral particles traveling along line-of-sight of the initial ion beam. While examples of mass spectrometer systems (e.g., GC-MS systems) incorporating the deflectors of the present disclosure are described in more detail herein, it should be understood that the deflectors described herein may find use in any ion detection system that relies on introduction of an inert gas therein. Illustrative examples of such ion detections systems include but are not limited to any off-axial device that may be deployed along the MS instrument direction such as off-axis API, off-axis ion optics, and off-axis detector optics.

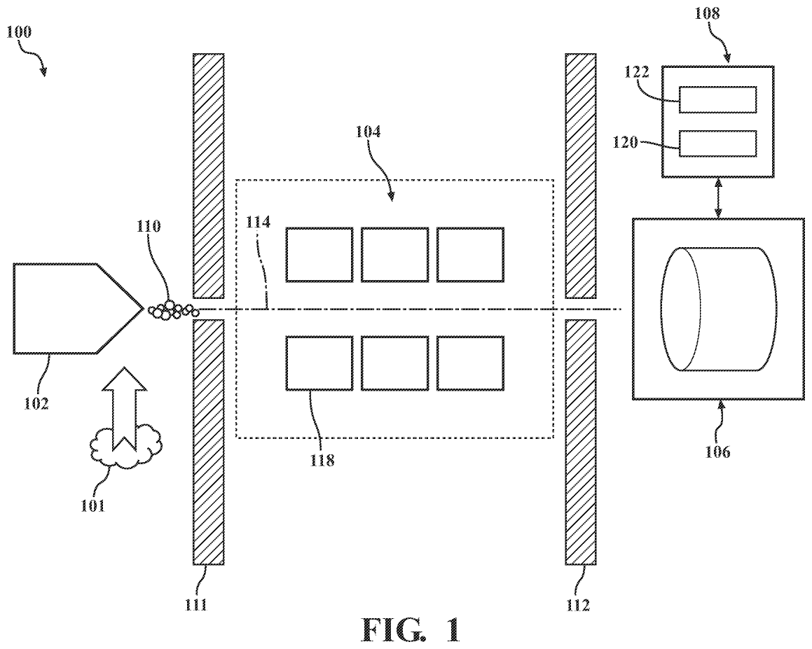

FIG. 1 schematically depicts an exemplary mass spectrometry system 100 according to one or more embodiments of the present disclosure. The mass spectrometry system 100 is depicted to generally include an ion source 102 configured to generate an ion beam 110, an optional reagent gas inlet 101, a mass analyzer 104 configured to manipulate the ion beam 110 (or various portions thereof including ions with different mass-to-charge ratios) along a first propagation axis 114, an ion detector assembly 106, and a digitizer 108. It should be appreciated that various components of the mass spectrometry system 100 have been omitted for the purposes of discussion and that the present disclosure is not limited to any particular type of mass spectrometry system. The depicted components (e.g., the ion source 102 and mass analyzer 104) may vary in form depending on the implementation and the type of mass spectrometry system incorporating the ion detector assembly 106.

In some embodiments, the mass spectrometry system 100 is a GC-MS system. In such embodiments, the ion source 102 may include a carrier gas source (e.g., one or more pressurized vessels containing suitable carrier gasses, illustratively He, N₂, and H₂), a sample injector, and a capillary column configured to separate different molecular species contained in a sample injected into the column. After separation, the molecules in the sample may be ionized.

The ion source 102 may in some embodiments also include suitable ionization hardware for ionization using a suitable ionization method (e.g., electron ionization, chemical ionization, inductively coupled plasma, etc.). As a result, the molecules in the sample that are carried via the carrier gas are ionized. The ion source 102 may also include an ion lens including one or more electrodes configured to generate a potential that guides the ion beam 110 along the first propagation axis 114.

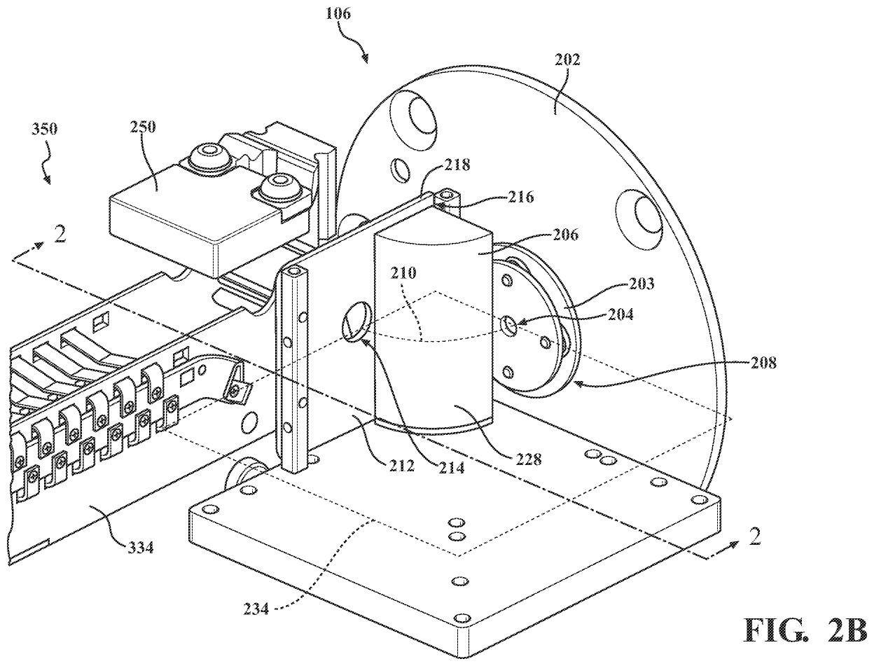

As a result of the presence of carrier gases that may be used in generating the ion beam 110, neutral particles (e.g., metastable state noble-gas atoms) may be present and propagate through the mass analyzer 104. Collisions between such neutral particles and other elevated-energy species may result in the generation of secondary ions that may be subsequently detected in the ion detector assembly 106. Such secondary ions may be generated along the ion path 114 and result in substantial noise in the system. Collisions may also occur within the ion detector assembly 106 proximate to a detection element (depicted in more detail in FIG. 3) configured to trigger detection events in addition to the ion beam 110 (or an electron beam generated therefrom) and decrease the dynamic range of a MS system 100. Accordingly, to aid in reducing the presence of such neutral particles within the ion detector assembly 106 proximate the detection element, the ion detector assembly 106 may include a deflector as provided herein configured to guide the ion beam 110 off of the first propagation axis 114 and onto a deflection path using an electric field. Because the neutral particles are not affected by the electric field, they are not guided towards the detection element, but are instead isolated by a grounded enclosure, thereby reducing the probability of secondary ions and background noise. Example embodiments of the ion detector assembly 106 will be described in greater detail herein.

The mass analyzer 104 may be configured to receive ions from the ion source 102 (e.g., through a particle shield that may serve as or include a conductance limit 111) and generate a variable electric field that guides ions of the ion beam 110 along the first propagation axis 114 into the ion detector assembly 106 (e.g., via a particle shield 112). The particle shields 111 and 112 may serve to block neutral particles and other undesired constituents from entering the ion detector assembly 106. The mass analyzer 104 is depicted to include a plurality of electrodes 118 for generating the electric field that guides the ions along the first propagation axis 114. The plurality of electrodes 118 may be arranged in a variety of different configurations (e.g., a quadrupole ion guide, an ion trap, an ion mobility device, etc.). The form of the first propagation axis 114 may vary depending on the configuration of the plurality of electrodes 118. As such, while the first propagation axis 114 is depicted to be a straight line, it should be appreciated that embodiments where the first propagation axis 114 is curved or non-linear are contemplated and within the scope of the present disclosure.

The plurality of electrodes 118 of the mass analyzer 104 may be coupled to a power source (not depicted). The power source may vary an electrical signal provided to the plurality of electrodes 118 in terms of frequency and/or amplitude to vary the electric field generated by the mass analyzer 104. Such a variable electric field within the mass analyzer may cause ions of the ion beam 110 with different mass-to-charge ratios to be emitted from the mass analyzer 104 along the first propagation axis 114 into the ion detector assembly 106 at different times. As the ions are emitted from the mass analyzer 104 along the first propagation axis 114, the front components of ion detector assembly 106 may direct the ions onto a detection element for generating electrical signals. The digitizer 108 may be communicably coupled to the ion detector assembly 106 to receive electric signals generated therefrom. The digitizer 108 may include a pulse counter 120 and/or an analog-to-digital converter 122. The output 122 of the digitizer 108 may store instruction or deliver real-time signal(s) that are accessible by the processor or a user computer in accordance with a suitable addressing scheme to display the spectral information (e.g., on a suitable display or graphical user interface) as a function of mass-to-charge ratio, thereby facilitating identifying the chemical constituents of the sample.

While the preceding example relates to a GC-MS system, it should be understood that the embodiments of the ion detector assembly 106 described herein may be usable in a variety of different kinds of mass spectrometry systems. For example, embodiments where the mass spectrometry system 100 is an inductively-coupled plasma mass spectrometry system or a liquid chromatography mass spectrometry system are contemplated and within the scope of the present disclosure.

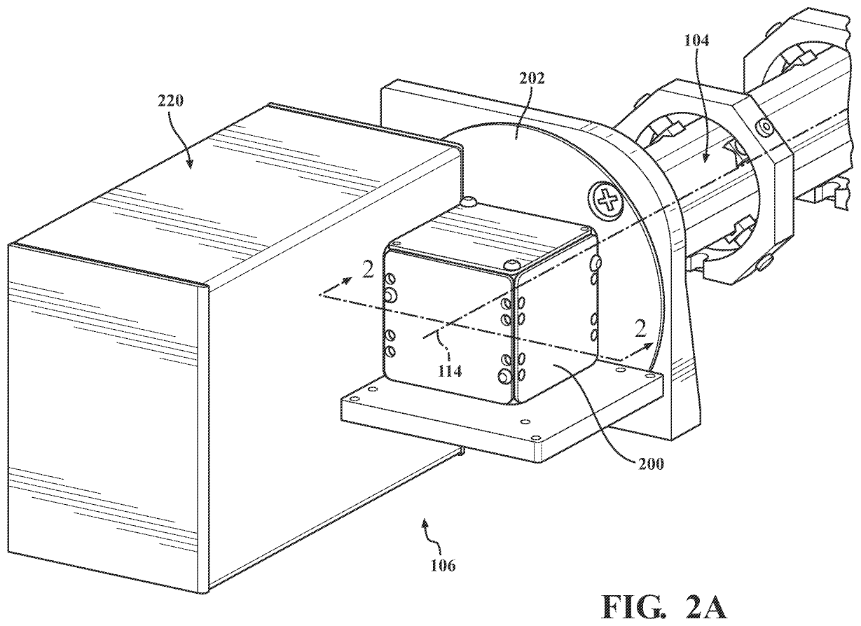

Referring now to FIGS. 2A, 2B, and 2C, the ion detector assembly 106 of the mass spectrometry system 100 described herein with respect to FIG. 1 is described in more detail, according to an exemplary embodiment. FIG. 2A depicts a perspective view of the ion detector assembly 106 coupled to a mass analyzer 104. FIG. 2B depicts a perspective view of the ion detector assembly 106 with a grounded enclosure 200 (see FIG. 2A) removed therefrom for purposes a visualization. FIG. 2C schematically depicts a cross-sectional view of the ion detector assembly 106 through the plane 2-2 in FIG. 2A, with the ion beam 110 (see FIG. 1) propagating therethrough.

Referring to FIGS. 2A and 2B, the ion detector assembly 106 includes a grounded enclosure 200 substantially surrounding the deflection region, a first particle shield 202 including an ion focusing lens set 203 with entry opening 204 for shaping an ion beam (e.g., the ion beam 110, see FIG. 1) propagating along the first propagation axis 114, a deflector 206 configured to generate an electric field in a deflection region 208 that deflects the ion beam out of alignment with the first propagation axis 114 along a deflection path 210, a second particle shield 212 including an ion exit opening 214, and an optional focusing lens set (optionally similar to 203) behind the second particle shield 212. The grounded enclosure optionally surrounds the deflection region in full or in part, optionally fully surrounds the deflection region. Optionally, the grounded enclosure at least surrounds the deflection region from a first particle shield to a second particle shield and above and below the deflection region from the plane of the deflection path.

A detection element 250 (see FIG. 2B, 2C, or 3) configured to convert the ion beam to electrons after deflection region may be provided. The first particle shield 202 and the second particle shield 212 serve to shield potentials of high voltage components (e.g., such as a conversion dynode 250 of the ion detector assembly 106 and a mass analyzer 104) and neutral particles propagating through the mass spectrometry system 100 (see FIG. 1). The ion entry opening 204 may be aligned with the first propagation axis 114 (e.g., the first propagation axis 114 may extend through a geometric center of the ion entry opening 204) to permit entry of the ion beam 110 into the ion detector assembly 106. The ion exit opening 214 may be aligned with the deflection path 210 (e.g., such that the center of the deflection path 210 extends through the ion exit opening 214) so that the ion beam 110, after being deflected by the deflector 206, propagates through the ion exit opening 214 for detection.

In some embodiments the first particle shield 202 extends at an angle relative to the second particle shield 212. In the depicted embodiment in FIGS. 2A-C, the first particle shield 202 extends perpendicular to the second particle shield 212, though embodiments where the first particle shield 202 and the second particle shield 212 are not perpendicular to one another are contemplated and within the scope of the present disclosure. The first particle shield 202 and the second particle shield 212 may define a corner region 216. The corner region 216 may represent a line of intersection between the first particle shield 202 and the second particle shield 212. For example, in the depicted embodiment, the second particle shield 212 includes an edge 218 that is disposed proximate to the first particle shield 202. In embodiments, the corner region 216 may be a point where the edge 218 of the second particle shield 212 contacts the first particle shield 202. In embodiments, the corner region 216 may mark a point where an imaginary extension of the second particle shield 212 (e.g. extending from the edge 218 and having the same cross-sectional shape as a remainder of the second particle shield 212) extends through the first particle shield 202 to form a corner.

Optionally, as described further below, the deflector 206 is configured such that the deflection surface 228 of the deflector 206 extends from a position proximate the ion entry opening 204, extending through a curve as defined above to a position proximate to the ion exit opening 214. In such a configuration the surface of the deflector does not physically block either the ion entry opening 204 or the ion exit opening 214. Thus, the ions in the ion beam 110 are not physically blocked but instead exposed to a deflector field generated by the deflector that gradually guides the ions through the defection path 210 toward the ion exit opening 214. Such a configuration substantially prevents altering the field between the edge of the deflector and the focusing lens set 203 that serves to shape the ion beam along the first ion path 114.

The grounded enclosure 200 serves to shield the components of the ion detector assembly 106 from bombardment by neutral particles and serves to ground the deflector 206 to shape the iso-potential lines associated with the electrical field generated by the deflector 206, as described herein from the potentials generated from other high voltage components near the detector. In embodiments, the grounded enclosure 200 includes the first particle shield 202, the second particle shield 212 (e.g., a top of the grounded enclosure 200 may be removed in FIG. 2A as seen in FIG. 2B to facilitate visualizing various components of the ion detector assembly 106). In embodiments, the grounded enclosure 200 delineates a boundary of the deflection region 208 in conjunction with the first particle shield 202 and the second particle shield 212. The grounded enclosure 200 may be located next to a detection cavity 220 in conjunction with the first particle shield 202 and the second particle shield 212. The second particle shield 212 may separate the deflection region 208 from the detection cavity 220. Various components (e.g., conversion dynodes, electron/photon multipliers, and a detection element) may be disposed in the detection cavity 220 to generate detectable signals from the ion beam 110 (see e.g. FIG. 2C).

Referring now to FIG. 2C, the deflector 206 is depicted to include a first rear surface 222 extending proximate to the first particle shield 202, a second rear surface 224 extending proximate to the second particle shield 212, and a vertex 226 where the first rear surface 222 meets the second rear surface 224. It is noted the vertex may or may not be present in the deflector. In embodiments, the vertex 226 is a transition (e.g., a corner, tip, curve, or the like) between the first rear surface 222 and the second rear surface 224. As shown in FIG. 2C, the vertex 226 is disposed proximate to the corner region 216. As a result, the space between the first and second rear surfaces 222 and 224 and the first and second particle shields 202 and 212 may be relatively small (e.g. on the order of 1 millimeter) compared to certain existing ion deflectors. In embodiments, the first and second rear surfaces 222 and 224 may extend substantially parallel to the first and second particle shields 202 and 202, respectively, to facilitate minimizing the separations between the first particle shield 202 and the first rear surface 222 and the second particle shield 212 and the second rear surface 224. It has been found that limiting the space between the deflector 206 and the first and second particle shields 202 and 212 prevents distortion of the electric field generated by the deflector 206, which aids in preventing the ions in the ion beam 110 from deviating from the deflection path 210.

The deflector 206 is depicted to further include a curved deflection surface 228 opposite the vertex 226 and extending between the first rear surface 222 and the second rear surface 224. The curved deflection surface 228 faces outward from the vertex 226 into the deflection region 208. In the cross-section depicted in FIG. 2C, the curved deflection surface 228 follows a circular arc extending between first and second outer edges 230 and 232 of the first and second rear surfaces 222 and 224. The first and second outer edges 230 and 232 may represent points where the electric field generated by the deflector 206 is spatially non-uniform. The design of the deflector 206, by including the first and second rear surfaces 222 and 224, which are disposed proximate to the first and second particle shields 202 and 212 and away from the deflection path 210, beneficially displaces such field non-uniformities from the ion beam 110, thereby facilitating the ions traveling along the deflection path 210. In embodiments, the shape of the curved deflection surface 228 corresponds to a desired shape of the deflection path 210 within the deflection region 208.

The deflector 206 may be conductively connected to a power supply (not depicted) so as to generate a potential difference, referred to herein as a “drag potential,” between the deflector 206 and the grounded enclosure 200 (see FIG. 2A). As a result of the drag potential, the electric field generated by the deflector 206 generally provides centripetal force radially proximate toward the vertex 226 and corner region 216, thereby facilitating the deflection path 210 following a curve, optionally with at least a portion of the curve having a constant or varied deflection radius r_{d} and optionally with an end disposed at (or proximate to) the vertex 226 depending on the shape of the curve defining the deflector surface 228. In embodiments, at least a portion of curved deflection surface 228 defines a minimal deflection radius of curvature r_{dmin}, as measured from the vertex 226. In embodiments, r_{dc} is equal to or approximately equal to 10 mm (e.g., greater than or equal to 5 mm and less than or equal to 15 mm), though deflectors having various sizes are contemplated and within the scope of the present disclosure. In embodiments, r_{dc} is less than r_{dmin}. In embodiments, r_{dc} is greater than or equal to 0.5*r_{dmin} and less than r_{dmin}. It has been found in some embodiments that maintaining a ratio of r_{dc} to r_{dmin}, above about 0.5, or optionally of roughly 10 mm, with minimal field non-uniformities facilitates the deflector 206 having a relatively high tolerance for a wide kinetic energy distribution of the ions in the ion beam 110.

As will be appreciated, the ion beam 110 may include ions with a plurality of different mass-to-charge ratios. For example, the mass-to-charge ratio (m/z) of the plurality of ions in the ion beam 110 may vary between 114 and 1022. As a result of the varying mass-to-charge ratio and the electric field generated by the mass analyzer 104 (see FIG. 1), the kinetic energy distribution of the plurality of ions may in the ion beam 110 may range from 0.1 eV to 75 eV. It has been found that the drag potential applied to the deflector 206 may be adjusted between 0V and −800V to compensate for such a wide kinetic energy distribution. That is, despite the ions in the ion beam 110 having different mass-to-charge ratios and kinetic energies, the drag potential can be adjusted such that each ion travels on or proximate to the deflection path 210 and is guided through the ion exit opening 214. The design of the deflector 206 has been found to improve tolerance for wide ranges of kinetic energy.

While the deflection path 210 is depicted as a single path (e.g., a single curve) extending between the ion entry opening 204 and the ion exit opening 214, it should be understood that ions in the ion beam 110 may not travel along precisely the same trajectories within the deflection region 208. The precise trajectory that a particular ion takes as a result of the electric field generated by the deflector 206 may vary depending on the mass-to-charge ratio of the ion and the initial kinetic energy of the ion. As such, the term “deflection path,” as used herein, does not refer to the trajectory of a particular ion, but rather a center of a measured/simulated distribution of trajectories for a plurality of ions having different mass-to-charge ratios and initial kinetic energies.

Referring now to FIG. 2C, in some embodiments, the deflection path 210 deviates from the first propagation axis 114 in a deflection plane (as shown illustratively at 234 in FIG. 2B). In some embodiments, at least a portion of the deflection path 210 is co-planar with the first propagation axis 114, such that both the first propagation axis 114 and the portion of the deflection path 210 are disposed in the deflection plane 234. Embodiments are also envisioned where the electric field generated by the deflector 206 causes the ion beam to deviate from the depicted deflection plane 234. For example, the potential field penetration of the conversion dynode 250 (see FIG. 2C) may cause the ion beam 110 to deviate from the deflection plane 234 and path 210. This potential focus mass ions radially to facilitate the ion transfer from the grounded enclosure 200 to the detection cavity 220. An optional focusing lens set can be added behind the particle shields 212, for a uni-field detector without a conversion dynode. Upon passing through the ion entry opening 204 into the deflection region 208, however, at least initially, the deflection path 210 may be disposed in the deflection plane 234 in conjunction with the first propagation axis 114. In embodiments, the deflection plane 234 extends through geometric centers of both the ion entry opening 204 and the ion exit opening 214. While the deflection plane 234 is depicted as a plane not including a vertical dimension (e.g., along the direction of the vertex 226, perpendicular to the first propagation axis 114), it should be understood that the deflection plane 234 may include a vertical dimension corresponding to the size of the (e.g., average diameter) of the ion beam 110 such that most or all the ions of the ion beam 110 (see FIG. 2C) are disposed within the deflection plane 234 when in the deflection region 208.

FIG. 2C depicts a cross-sectional view of the ion detector assembly 106 through the deflection plane 234. As shown, the electric field generated via the deflector 206 causes the deflection path 210 to deviate from the first propagation axis 114. An ion exit axis 236, extending substantially through a geometric center of the ion exit opening 214 and substantially perpendicular to the second particle shield 212, is also depicted. As shown, the ion exit axis 236 intersects the first propagation axis 114 at an intersection point 238. The radius r_{ic} is depicted to be the distance from the vertex 226 to the propagation axis 114 or 236. In embodiments, the deflector radius of curvature r_{dc} of the curved deflection surface 228 is greater than or equal to 0.5*r_{dmin} (optionally greater than or equal to 0.33*r_{dmin}, optionally greater than or equal to 0.40*r_{dmin}) and less than r_{ic} to facilitate generating a favorable electric field for guiding the ion beam 110 along the deflection path 210, as described herein.

As a result of the deflector 206 and the conversion dynode 250, the deflection path 210 may include a post-exit portion 240 (e.g., downstream of the ion exit opening 214) that may extend at an angle of greater than or equal to 90° relative to the first propagation axis 114 (e.g. such that ion beam 110 is bent back at least partially towards the mass analyzer 104 (see FIG. 1). Such a deflection amount may aid in reducing the effects of any neutral particles and photons that may be contained in the deflection region 208. This deflection may be rendered possible by the iso-potential lines associated with the electric field generated via the deflector 206.

FIG. 2C depicts a plurality of iso-potential lines associated with an electric field generated when a drag potential of +/−450 V is applied to the deflector 206. Near the curved deflection surface 228 (e.g., between the curved deflection surface 228 and the deflection path 210) an inner plurality of inner iso-potential lines 242 substantially follows the shape of the curved deflection surface 228 between the first and second outer edges 230 and 232 of the first and second rear surfaces 222 and 224. The plurality of inner iso-potential lines 242 follow substantially arcs substantially in conformity with the surface of the deflector 228 for substantially an entirety (e.g., greater than or equal to 70%) of the angular distance between the ion entry opening 204 and the ion exit opening 214, as measured from the vertex 226. Such a shape of the plurality of inner iso-potential lines 242 indicates that the electric field directions extend radially proximate to the vertex 226 and corner region 216, tending to direct the ion beam 110 along the depicted deflection path 210. As a result of the structure of the deflector 206 described herein, the plurality of inner iso-potential lines 242 may more closely approximate the deflection path 210 in shape (e.g., extend within 10° thereof) for a greater portion of the deflection region 208 than in certain existing ion deflectors, providing an electric field that tends to confine propagation of the ions along the deflection path 210.

The plurality of iso-potential lines also includes a plurality of outer iso-potential lines 244. The deflection path 210 may intersect the plurality of outer iso-potential lines 244. The electric field generated via the deflector 206 at such points of intersection may tend to effect the shape of the deflection path 210. As depicted in FIG. 2C, proximate the ion entry opening 204, successive portions of the plurality of outer iso-potential lines 244 encountered by the ion beam 110 extend at decreasing angles relative to the first propagation axis 114. As a result within the deflection region 208, the ions tend to be deflected at increasing angles relative to the first propagation axis 114, which may tend to result in the deflection path 210 having a curved shape that substantially deviates from the first propagation axis 114.

Moreover, proximate to the ion exit opening 214, the plurality of outer iso-potential lines 244 extend almost parallel (e.g., within 20° of parallel, within 10° of parallel) to the ion exit axis 236. FIG. 2C depicts an approximate electric field line 246, extending perpendicular to some of the plurality of outer iso-potential lines 244. As shown, the approximate electric field line 246, representative of the direction at which normals to the plurality of outer iso-potential lines 244 extend proximate to the ion exit opening 214, extends substantially perpendicular (e.g., within 20° of perpendicular, within 10° of perpendicular) to the ion exit axis 236 towards the first particle shield 202. Such iso-potential lines indicate the presence of an electric field that tends to force the ion beam 110 inward (e.g., towards the vertex 226) and away from an outer boundary 248 of the ion exit opening 214. Such a directionality of the electric field may reduce ion loss at the second particle shield 212. The inward direction of the electric field proximate to the ion exit opening 214 may also aid in the ion detector assembly 106 tolerating wider ranges of kinetic energy distributions than certain existing ion deflectors.

FIG. 3 schematically depicts a cross-sectional view of an ion detector assembly 300, according to another example embodiment of the present disclosure. The ion detector assembly 300 may include functions similar to the ion detector assembly 106 described herein with respect to FIGS. 2A-2C. In embodiments, the ion detector assembly 300 may be used in place of the ion detector assembly 106 in the mass spectrometry system 100 described herein with respect to FIG. 1.

The ion detector assembly 300 includes a grounded enclosure 302, a first particle shield 304 including an ion entry opening 306 for receiving an ion beam 328 (e.g., corresponding to the ion beam 110, see FIG. 1), a deflector 314 configured to generate an electric field in a deflection region 320 that deflects the ion beam 328, and a second particle shield 308 including an ion exit opening 310. The first particle shield 304 and the second particle shield 308 serve to shield high voltage components of the ion detector assembly 300 from neutral particles. For example, the ion detector assembly 300 is depicted to include a conversion dynode 326 that is configured to convert the ion beam 328 into an electron beam 330 to facilitate detection. The first particle shield 304 and the second particle shield 308 may block neutral particles from entering a cavity 322 (e.g., defined by the grounded enclosure 302 and the second particle shield 308) containing the conversion dynode 326, thereby preventing signal noise and protecting the conversion dynode 326 and any downstream components. The ion entry opening 204 may be aligned with a first propagation axis (e.g. corresponding to the first propagation axis 114 depicted in FIG. 1) to permit entry of the ion beam 328 into the ion detector assembly 300. The ion exit opening 310 may permit entry of the ion beam 328 into the cavity 322 for conversion into the electron beam 330 via the conversion dynode 326 and provision to a detection cavity 332. The detection cavity 332 may contain an electron/photon multiplier to amplify the electron beam 330 prior to incidence on a detection element 350. The detection element 350 may convert the electron beam 330 to an electric signal that is provided to a computing system (e.g., the digitizer 108 described herein with respect to FIG. 1) for subsequent analysis.

The first particle shield 304 and the second particle shield 308 optionally converge with one another (e.g., contact one another, or an end of one of the first particle shield 304 and the second particle shield 308 may be disposed proximate to the other one of the first particle shield 304 and the second particle shield 308) to form the corner region 312. The deflector 314 includes a vertex 316 disposed proximate to the corner region 312 and include a curved deflection surface 318. The deflector 314 may function similar (e.g., to generate a similar electric field to deflect the ion beam 328 along a similar deflection path) to the deflector 206 described herein with respect to FIGS. 2A-2C.

The ion detector assembly 300 is depicted to further include a first ion focusing lens 336 disposed proximate to the ion entry opening 306 and a second ion focusing lens 338 disposed proximate to the ion exit opening 324. Potentials applied to the first ion focusing lens 336 and the second ion focusing lens 338 may cause the first and second ion focusing lenses 336 and 338 to focus the ion beam 328 at the ion entry opening 306 and the ion exit opening 310, thereby facilitating the ion entry opening 306 and the ion exit opening 310 being smaller in size (e.g., while still permitting an entirety of the ion beam 328 to pass therethrough) than if the first ion focusing lens and the second ion focusing lens 338 were not incorporated. The smaller ion entry opening 306 and ion exit opening 310 may aid in blocking more neutral species to further suppress background noise.

In some embodiments, the grounded enclosure 302 defines the detection cavity 332. An electron or photon multiplier 334 may be disposed in the detection cavity 332 and positioned to receive the electron beam 330 from the conversion dynode 326. The electron or photon multiplier 334 may amplify the electron beam 330 prior to incidence on the detection element 350 to facilitate conversion to an electric signal that may be processed and/or display (e.g., via the digitizer 108 described herein with respect to FIG. 1). In embodiments, the detection cavity 332 is defined by a detection enclosure 340. The detection enclosure 340 may be integrally formed with the grounded enclosure 302 or a separate component. The detection enclosure 340 may define an electron entry opening 342 facilitating entry of the electron beam 330 into the detection cavity 332 and blocking neutral particles that may induce noise.

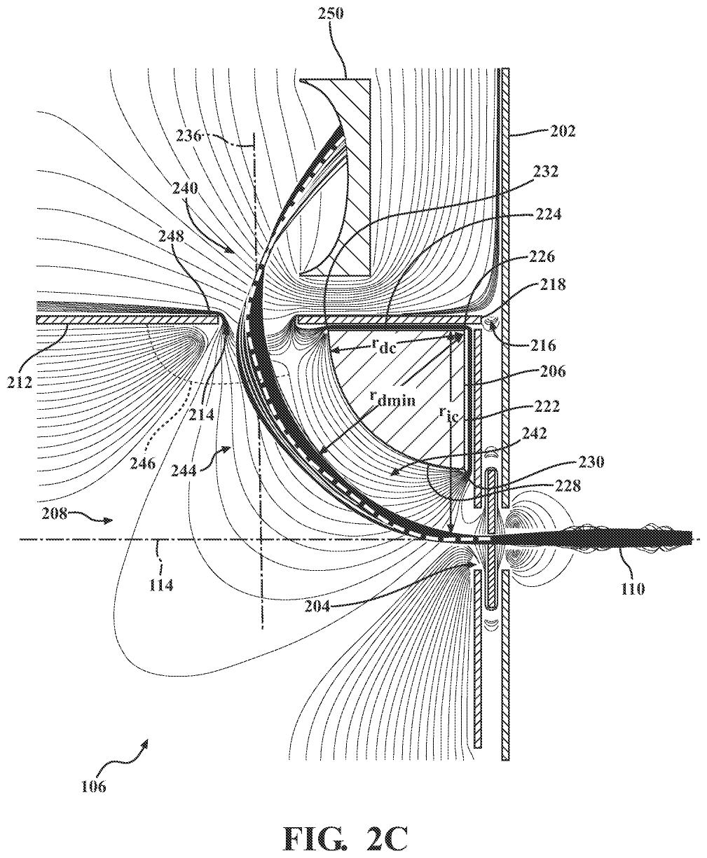

In the example detector assembly 106 described herein with respect to FIGS. 2A-2C, the deflector 206 was for exemplary purposes only quarter cylinder-shaped, with the cylinder being centered on the vertex 226. As such, the deflector 206 includes a substantially uniform cross-sectional area as a function of position along the vertex 226. It should be understood that alternative deflector geometries, with non-uniform cross-sectional areas as a function of position along a vertex (e.g. similar in structure to the vertex 226 described herein with respect to FIGS. 2A-2C) or of varying shapes are contemplated and within the scope of the present disclosure. For example, FIGS. 4, 5, 6, and 7 schematically depict deflector assemblies 400, 500, 600, and 700, respectively, each including a defector having a different shape. The examples depicted in FIGS. 4, 5, 6, and 7 are only examples of the contemplated geometries. Each of the deflector assemblies 400, 500, 600, and 700 depicted in FIGS. 4, 5, 6, and 7 may include components of the detector assembly 106 described herein with respect to FIGS. 2A-2C. Accordingly, like reference numerals are incorporated into FIGS. 4, 5, 6, and 7 to signify the incorporation of such like components.

In the deflector assembly 400 depicted in FIG. 4, a deflector 402 is disposed in place of the deflector 206 of the detector assembly 106 described herein with respect to FIGS. 2A-2C. The deflector 402 may include first and second rear surfaces (not depicted) extending proximate to the first and second particle shields 202 and 212, respectively. The rear surfaces may meet at a vertex 404 that is disposed proximate to the corner region 216. The deflector 402 is a quarter of the sphere, with the sphere being centered on the vertex 404. The deflector 402 also includes a curved deflection surface 406 extending between the rear surfaces and following a curved contour. In some embodiments, a cross-section of the deflector 202 taken through the deflection plane 234 is similar in shape to the deflector 206 described herein with respect to FIG. 2C.

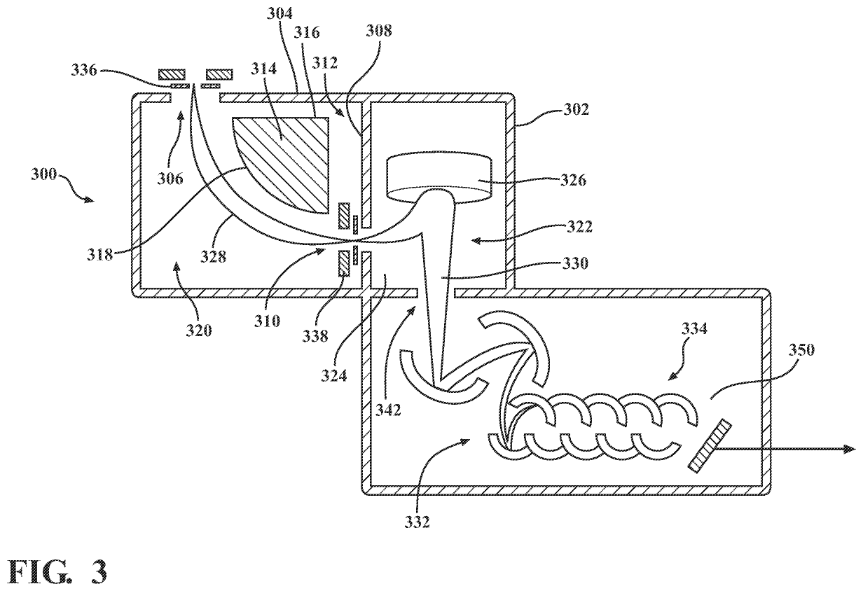

In the deflector assembly 500 depicted in FIG. 5, a deflector 502 is disposed in place of the deflector 206 of the detector assembly 106 described herein with respect to FIGS. 2A-2C. The deflector 502 may include first and second rear surfaces (not depicted) extending proximate to the first and second particle shields 202 and 212, respectively. The rear surfaces may meet at a vertex 504 that is disposed proximate to the corner region 216. The deflector 502 is substantially a quarter of an ellipsoid, with a major axis of the ellipsoid coinciding with the vertex 504. The deflector 502 also includes a curved deflection surface 506 extending between the rear surfaces and following a curved contour. In some embodiments, a cross-section of the deflector 502 taken through the deflection plane 234 is similar in shape to the deflector 206 described herein with respect to FIG. 2C.

In the deflector assemblies 400 and 500 depicted in FIGS. 4 and 5, the deflectors 402 and 502 are each depicted to include a maximum cross-sectional area in the deflection plane 234. Such a configuration may aid in iso-potential lines associated with electric fields generated thereby substantially corresponding to a desired deflection path (e.g., such as the deflection path 210 described herein with respect to FIGS. 2A-2C) via the large radius of curvature of the curved deflection surfaces 406 and 506, respectively. However, embodiments are also envisioned where a maximum cross area of the deflector is offset from the deflection plane 234.

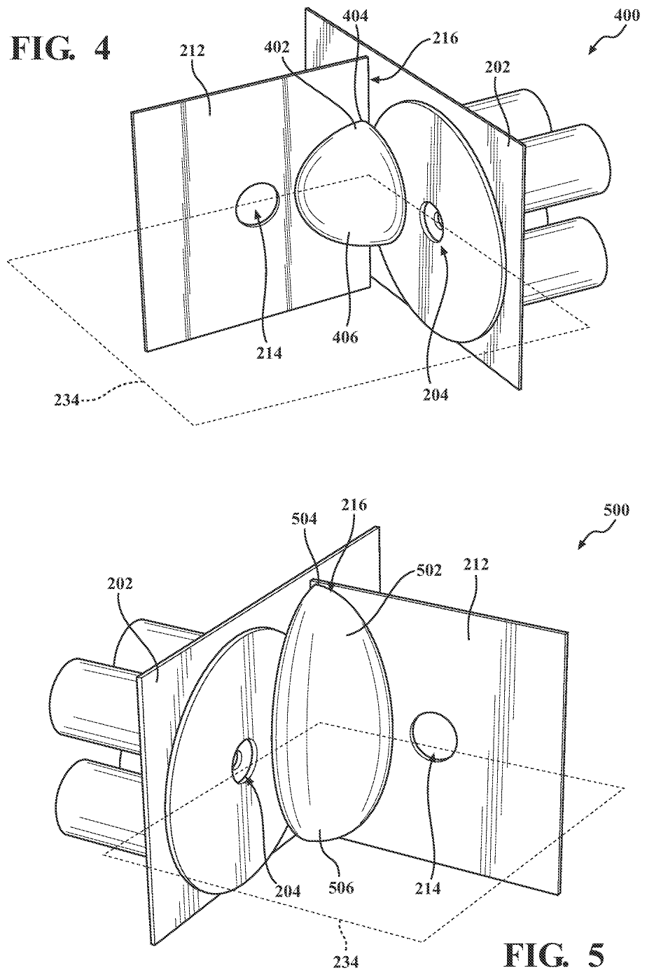

For example, in the deflector assembly 600 depicted in FIG. 6, a deflector 602 is disposed in place of the deflector 206 of the detector assembly 106 described herein with respect to FIGS. 2A-2C. The deflector 602 may include first and second rear surfaces (not depicted) extending proximate to the first and second particle shields 202 and 212, respectively. The rear surfaces may meet at a vertex 604 that is disposed proximate to the corner region 216. The deflector 602 is substantially a quarter of an hourglass-shape and includes a curved deflector surface 606 extending between the rear surfaces. As shown, the cross-section area of the deflector 602 includes a minimum value in the deflection plane 234. In embodiments, the cross-sectional radius of the deflector 602 in the deflection plane 234 is less than that associated with the deflectors 206, 400, and 500 described herein with respect to FIGS. 2A-2C, 4, and 5. The cross-sectional area of the deflector 602 increases as a function of distance from the deflection plane 234 along the vertex 604. As a result, the curved deflection surface 606 is a concave surface including surface normals that point towards the deflection plane 234, even at positions displaced from the deflection plane 234. As a result, the electric field generated by the deflector 602 may cause an ion beam to travel along a curved deflection path that is similar in shape to the curved deflection path 210 described herein with respect to FIGS. 2A-2C, while vertically confining the ions proximate to the deflection plane 234.

In some embodiments, end portions 608 of the deflector 602 are quarter cylinder-shaped sections including a radius (as measured from the vertex 604) rₒ. In embodiments, the radius rₒ may extend outward to provide a proper potential coverage over the deflection path 210. Such a correspondence may beneficially facilitate the deflector 602 vertically confining the ions within or proximate to the deflection plane 234 to facilitate their propagation through the ion exit opening 214.

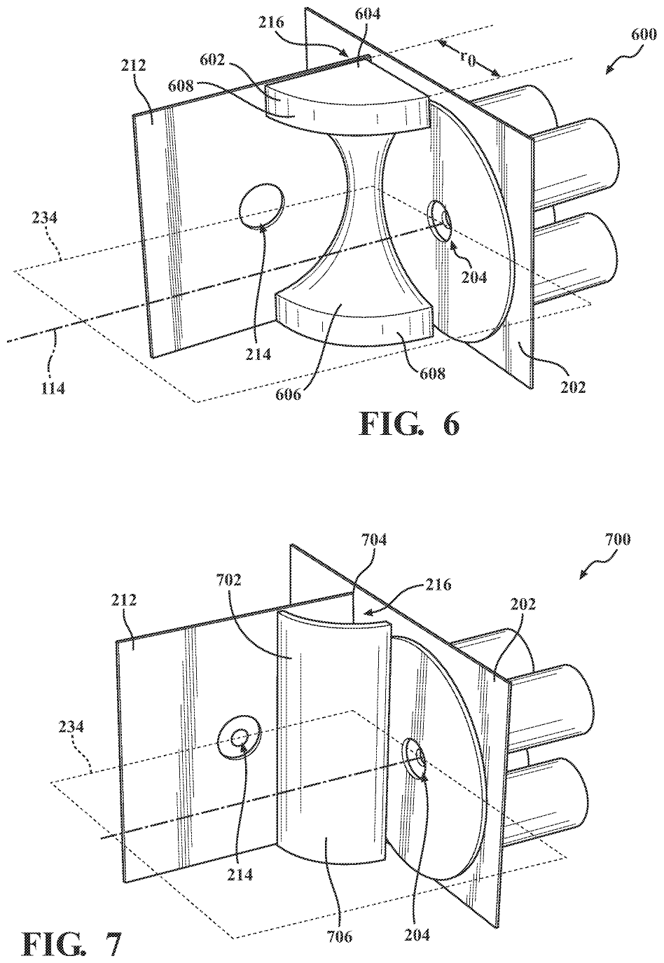

In the deflector assembly 700 depicted in FIG. 7 a deflector 702 is disposed in place of the deflector 206 of the detector assembly 106 described herein with respect to FIGS. 2A-2C. The deflector 702 may include first and second rear surfaces (not depicted, or optionally absent) extending proximate to the first and second particle shields 202 and 212, respectively. The rear surfaces may meet at a vertex 704 that is disposed proximate to the corner region 216. The deflector 702 is a quarter of a cylinder, with a major axis of the cylinder coinciding with the vertex 704. The deflector 702 also includes a curved deflection surface 706 extending between the rear surfaces and following a curved contour. In some embodiments, a cross-section of the deflector 702 taken through the deflection plane 234 is similar in shape to the deflector 206 described herein with respect to FIG. 2C.

The present disclosure is not limited to deflectors having particular three-dimensional geometries. Deflectors in accordance with the present disclosure may include curved deflection surfaces following a variety of different three dimension geometries (e.g., hyperboloid, sphere, cylinder, elliptic cylinder, conical, toroidal). Any suitable geometry may be used.

It should now be understood that embodiments of deflectors for detector assemblies as well as mass spectrometry systems including the same have been shown and described. The deflectors described herein include rear surfaces meeting at a vertex that is disposed proximate to a corner region where a pair of particle shields intersect one another. Opposite the vertex, the deflectors include a curved deflection surface facing outwards towards a deflection path. Electric fields generated by the deflectors described herein beneficially include reduced distortion fields as compared to certain existing ion deflectors designs and may beneficially tend to provide force extending radially inward toward the vertex to a greater extent than existing designs. Such field characteristics render the detector assemblies of the present disclosure more tolerant to ion beams with ions having wide distributions of kinetic energies, facilitating less noisy measurement results while blocking noise-inducing neutral species from reaching detector components.

### Exemplary Aspects

Example 1. Provided are ion detector assemblies including:

a first particle shield comprising an ion entry opening for receiving an ion beam propagating along a first propagation axis;

a deflector configured to generate an electric field in a deflection region that deflects the ion beam out of alignment with the first propagation axis along a deflection path;

a second particle shield comprising an ion exit opening; and

a detection element configured to convert and multiply the ion beam to electrons after deflection via the deflector, wherein:
the first particle shield extends at an angle relative to the second particle shield,
the first particle shield and the second particle shield define a corner region, and
the deflector comprises:
   a first rear surface extending proximate to the first particle shield;
   a second rear surface extending proximate to the second particle shield,
   a vertex where the first rear surface meets the second rear surface, the vertex being disposed proximate to the corner region; and
   a curved deflection surface opposite the vertex and extending between the first rear surface and the second rear surface.

Example 2. The ion detector assembly of example 1 or any other example alone or in combination, wherein the first rear surface extends parallel to the first particle shield and the second rear surface extends parallel to the second particle shield.

Example 3. The ion detector assembly of example 1 or any other example alone or in combination, wherein the angle at which the first particle shield extends relative to the second particle shield is 90°.

Example 4. The ion detector assembly of example 3 or any other example alone or in combination, wherein a portion of the deflection path extends at a deflection angle of at least 90° relative to the first propagation axis.

Example 5. The ion detector assembly of example 1 or any other example alone or in combination, wherein:

the deflection path deviates from the first propagation axis in a deflection plane, and

the deflection plane extends through both the ion entry opening and the ion exit opening.

Example 6. The ion detector assembly of example 5, wherein, in a cross section of the deflector taken through the deflection plane, the curved deflection surface follows a circular arc extending between a first outer edge of the first rear surface and a second outer edge of the second rear surface.

Example 7. The ion detector assembly of example 1 or any other example alone or in combination, wherein, within the deflection region, the electric field is configured to cause the deflection path to comprise a deflection radius with an end disposed at vertex.

Example 8. The ion detector assembly of example 7, wherein:

at least a portion of the curved deflection surface comprises a deflector radius of curvature, as measured from the vertex; and

the deflector radius of curvature is less than the minimal deflection radius of curvature r_{dmin}.

Example 9. The ion detector assembly of example 8, wherein the deflector radius of curvature is greater than or equal to half of the minimal deflection radius of curvature r_{dmin}.

Example 10. The ion detector assembly of example 1 or any other example alone or in combination, wherein the vertex extends substantially perpendicular to the first propagation axis.

Example 11. The ion detector assembly of example 10, wherein the deflector is substantially a quarter of a sphere centered on the vertex.

Example 12. The ion detector assembly of example 10, wherein the deflector is substantially a quarter of an ellipsoid centered on the vertex.

Example 13. The ion detector assembly of example 10, wherein the deflector comprises substantially a quarter of a cylinder centered on the vertex.

Example 14. The ion detector assembly of example 10, wherein the deflector comprises a cross-sectional area that varies as a function of position along the vertex.

Example 15. The ion detector assembly of example 14, wherein centers of the ion entry opening and the ion exit opening are disposed in a deflection plane containing the cross-sectional area.

Example 16. The ion detector assembly of example 15, wherein a minimum cross-sectional area of the deflector is contained in the deflection plane.

Example 17. The ion detector assembly of example 15, wherein a maximum cross-sectional area of the deflector is contained in the deflection plane.

Example 18. The ion detector assembly of example 1 or any other example alone or in combination, further comprising one or more ion focusing lenses disposed proximate to the ion entry opening and the ion exit opening.

Example 19. The ion detector assembly of example 1 or any other example alone or in combination, further comprising a conversion dynode disposed at an end of the deflection path, the conversion dynode configured to convert the ion beam into an electron beam.

Example 20. The ion detector assembly of example 19, further comprising an electron or photon multiplier disposed between the detection element and the conversion dynode.

Example 21. A mass spectrometry system comprising:

an ion source generating an ion beam;

a mass analyzer configured to guide the ion beam along a first propagation axis; and

a ion detector assembly comprising:
a pair of particle shields extending at an angle to one another and forming a corner region, the pair of particle shields comprising an ion entry opening for receiving the ion beam and an ion exit opening;
a deflector configured to generate an electric field in a deflection region that deflects the ion beam out of alignment with the first propagation axis along a deflection path extending through the ion exit opening, the deflector comprising a pair of rear surfaces and a vertex where the pair of rear surfaces meet; and
a detection element configured to generate electronic signals from the ion beam after deflection via the deflector, wherein the electric field generated by the deflector comprises iso-potential lines that extend within 10° of perpendicular to the one of the particle shields of the pair of particle shields in an area proximate to the ion exit opening.

Example 22. The mass spectrometry system of example 21 or any other claim alone or in combination, further comprising a grounded enclosure configured to shape the iso-potential lines within the deflection region, the grounded enclosure surrounding the deflection region and the detection element.

Example 23. The mass spectrometry system of example 22, wherein one of the particle shields of the pair of particle shields is configured to block the detection element from neutral species propagating through the mass analyzer.

Example 24. The mass spectrometry system of example 21 or any other example alone or in combination, wherein successive portions of the iso-potential lines extending proximate to the ion entry opening encountered by the ion beam extend at decreasing angles relative to the first propagation axis such that, within the deflection region, the deflection path comprises a deflection radius with an end disposed at the vertex.

Example 25. The mass spectrometry system of example 24, wherein the deflector comprises a curved deflection surface, wherein at least a portion of the curved deflection surface comprises a deflector radius of curvature, as measured from the vertex, that is greater than or equal to half of the deflection radius.

Example 26. The mass spectrometry system of example 25, wherein:

the vertex is disposed proximate to the corner region; and

the curved deflection surface is opposite the vertex and extends between the pair of rear surfaces.

Example 27. The mass spectrometry system of example 21 or any other example alone or in combination, wherein the iso-potential lines extend parallel to the rear surfaces proximate to the pair of particle shields.

Example 28. The mass spectrometry system of example 21 or any other example alone or in combination, wherein the vertex extends perpendicular to the first propagation axis.

Example 29. The mass spectrometry system of example 28, wherein the deflector comprises a quarter of a sphere centered on the vertex, a quarter of an ellipsoid centered on the vertex, or a quarter of a cylinder centered on the vertex.

Example 30. The mass spectrometry system of example 28, wherein the deflector comprises a cross-sectional area that varies as a function of position along the vertex.

Example 31. The mass spectrometry system of example 21 or any other example alone or in combination, wherein the ion detector assembly further comprises one or more ion focusing lenses disposed proximate to the ion entry opening and the ion exit opening.

Example 32. The mass spectrometry system of example 21 or any other example alone or in combination, wherein the ion detector assembly further comprises a conversion dynode disposed at an end of the deflection path, the conversion dynode configured to convert the ion beam into an electron beam.

Example. 33. The mass spectrometry system of example 32, wherein the ion detector assembly further comprises an electron/photon multiplier disposed between the detection element and the conversion dynode.

Example 34. A method comprising:

generating an ion beam propagating along a first propagation axis;

blocking neutral particles propagating with the ion beam by transmitting the ion beam through an ion entry opening of a first particle shield;

deflecting the ion beam off of the first propagation axis onto a deflection path by generating an electric field using a deflector disposed proximate a corner region disposed at an intersection between the first particle shield and a second particle shield, wherein the deflector comprises a pair of rear surfaces and a vertex where the pair of rear surfaces meet, the vertex being disposed proximate the corner region;

blocking additional neutral particles by transmitting the ion beam through an ion exit opening in the second particle shield; and

generating a detection signal from the ion beam using a detection element, wherein the electric field generated using the deflector comprises iso-potential lines that extend within 10° of perpendicular to the second particle shield in an area proximate to the ion exit opening.

Example 35. The method of example 34 or any other example alone or in combination, further comprising focusing the ion beam at one or more of the ion entry opening and the ion exit opening using one or more ion focusing lenses.

Example 36. The method of example 35, wherein:

ions in the ion beam comprise a plurality of mass to charge ratios, and applying a plurality of combinations of voltages to the deflector to direct the ions in the ion beam through the ion exit opening.

Example 37. The method of example 35, further comprising adjusting voltages applied to the deflector and to compensate for a kinetic energy distribution of the ions in the ion beam.

Example 38. The method of example 37, wherein the kinetic energy distribution includes kinetic energies ranging from 0.1 eV to 75 eV.

Example 39. The method of example 34 or any other example alone or in combination, further comprising generating an electron beam from the ion beam using a conversion dynode disposed at an end of the deflection path.

Example 40. The method of example 39, further comprising amplifying the electron beam using an electron/photon multiplier disposed between the conversion dynode and the detection element.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Various aspects of the above-described embodiments may be used alone, in combination, or in a variety of arrangements not specifically discussed in the described embodiments. Embodiments are therefore not limited in their application to the details and arrangement of components set forth in the foregoing description or illustrated in the drawings. For example, aspects described in one embodiment may be combined in any manner with aspects described in other embodiments.

Further, though advantages of some embodiments are indicated, it should be appreciated that not every embodiment will include every described advantage. Some embodiments may not implement any features described as advantageous herein. Accordingly, the foregoing description and drawings are by way of example only.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Use of ordinal terms such as “first,” “second,” “third,” etc., in the claims to modify a claim element does not by itself connote any priority, precedence, or order of one claim element over another, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

The phrase “and/or” as used herein in the specification and in the claims, should be understood to mean “either or both” of the elements so conjoined, i.e., elements that are conjunctively present in some cases and disjunctively present in other cases.

In the claims, as well as in the specification above, all transitional phrases such as “comprising”, “including”, “carrying”, “having”, “containing”, “involving”, “holding”, “composed of”, and the like are to be understood to be open-ended, i.e., to mean including but not limited to. The transitional phrases “consisting of” and “consisting essentially of” shall be closed or semi-closed transitional phrases, respectively.

What is claimed is:

1. An ion detector assembly comprising:
a first particle shield comprising an ion entry opening for receiving an ion beam propagating along a first propagation axis;
a deflector configured to generate an electric field in a deflection region that deflects the ion beam out of alignment with the first propagation axis along a deflection path;
a second particle shield comprising an ion exit opening; and
a detection element configured to convert and multiply the ion beam to electrons after deflection via the deflector, wherein:
the first particle shield extends at an angle relative to the second particle shield,
the first particle shield and the second particle shield define a corner region, and
the deflector comprises:
a first rear surface extending proximate to the first particle shield;
a second rear surface extending proximate to the second particle shield,
a vertex where the first rear surface meets the second rear surface, the vertex being disposed proximate to the corner region; and
a curved deflection surface opposite the vertex and extending between the first rear surface and the second rear surface.

2. The ion detector assembly of claim 1, wherein the first rear surface extends parallel to the first particle shield and the second rear surface extends parallel to the second particle shield.

3. The ion detector assembly of claim 1, wherein a portion of the deflection path extends at a deflection angle of at least 90° relative to the first propagation axis.

4. The ion detector assembly of claim 1, wherein within the deflection region the electric field is configured to cause the deflection path to comprise a deflection radius with an end disposed at a vertex.

5. The ion detector assembly of claim 4, wherein:
at least a portion of the curved deflection surface comprises a deflector radius of curvature, as measured from the vertex; and
the deflector radius of curvature is less than a minimal deflection radius of curvature r_{dmin}.

6. The ion detector assembly of claim 5, wherein the deflector radius of curvature is greater than or equal to half of a minimal deflection radius of curvature r_{dmin}.

7. The ion detector assembly of claim 1, wherein the deflector is a quarter of a sphere centered on the vertex, or wherein the deflector is a quarter of an ellipsoid centered on the vertex, or wherein the deflector comprises a quarter of a cylinder centered on the vertex.

8. The ion detector assembly of claim 1, wherein the deflector comprises a cross-sectional area that varies as a function of position along the vertex.

9. The ion detector assembly of claim 8, wherein a center of the ion entry opening and a center of the ion exit opening are disposed in a deflection plane containing the cross-sectional area.

10. A mass spectrometry system comprising:
an ion source generating an ion beam;
a mass analyzer configured to guide the ion beam along a first propagation axis; and
an ion detector assembly comprising:
a pair of particle shields extending at an angle to one another and forming a corner region, the pair of particle shields comprising an ion entry opening for receiving the ion beam and an ion exit opening;
a deflector configured to generate an electric field in a deflection region that deflects the ion beam out of alignment with the first propagation axis along a deflection path extending through the ion exit opening, the deflector comprising a pair of rear surfaces and a vertex where the pair of rear surfaces meet; and
a detection element configured to generate electronic signals from the ion beam after deflection via the deflector, wherein the electric field generated by the deflector comprises iso-potential lines that extend within 10° of perpendicular to one of the particle shields of the pair of particle shields in an area proximate to the ion exit opening.

11. The mass spectrometry system of claim 10, further comprising a grounded enclosure configured to shape the iso-potential lines within the deflection region, the grounded enclosure surrounding the deflection region and the detection element.

12. The mass spectrometry system of claim 10, wherein one of the particle shields of the pair of particle shields is configured to block the detection element from neutral species propagating through the mass analyzer.

13. The mass spectrometry system of claim 10, wherein successive portions of the iso-potential lines extending proximate to the ion entry opening encountered by the ion beam extend at decreasing angles relative to the first propagation axis such that, within the deflection region, the deflection path comprises a deflection radius with an end disposed at the vertex.

14. The mass spectrometry system of claim 13, wherein the deflector comprises a curved deflection surface, wherein at least a portion of the curved deflection surface comprises a deflector radius of curvature, as measured from the vertex, that is greater than or equal to half of the deflection radius.

15. The mass spectrometry system of claim 10, wherein the iso-potential lines extend parallel to the rear surfaces proximate to the pair of particle shields.

16. The mass spectrometry system of claim 10, wherein the deflector comprises a quarter of a sphere centered on the vertex, a quarter of an ellipsoid centered on the vertex, a quarter of a cylinder centered on the vertex, or wherein the deflector comprises a cross-sectional area that varies as a function of position along the vertex.

17. A method detecting an ion comprising:
generating an ion beam propagating along a first propagation axis;
blocking neutral particles propagating with the ion beam by transmitting the ion beam through an ion entry opening of a first particle shield;
deflecting the ion beam off of the first propagation axis onto a deflection path by generating an electric field using a deflector disposed proximate a corner region disposed at an intersection between the first particle shield and a second particle shield, wherein the deflector comprises a pair of rear surfaces and a vertex where the pair of rear surfaces meet, the vertex being disposed proximate the corner region;
blocking additional neutral particles by transmitting the ion beam through an ion exit opening in the second particle shield; and
generating a detection signal from the ion beam using a detection element, wherein the electric field generated using the deflector comprises iso-potential lines that extend within 10° of perpendicular to the second particle shield in an area proximate to the ion exit opening.

18. The method of claim 17, further comprising focusing the ion beam at one or more of the ion entry opening and the ion exit opening using one or more ion focusing lenses.

19. The method of claim 17, wherein:
ions in the ion beam comprise a plurality of mass to charge ratios, and
applying a plurality of combinations of voltages to the deflector to direct the ions in the ion beam through the ion exit opening.

20. The method of claim 17, further comprising adjusting voltages applied to the deflector and to compensate for a kinetic energy distribution of the ions in the ion beam.
